(19) United States
(12) Patent Application Publication
(10) Pub. No.: US 2013/0162918 A1
(43) Pub. Date: Jun. 27, 2013

(54) DRIVE CIRCUIT OF DISPLAY DEVICE, DISPLAY DEVICE, AND METHOD OF DRIVING DISPLAY DEVICE

(71) Applicants: Masashi Mayumi, Osaka-shi (JP); Akinori Kubota, Osaka-shi (JP); Hiroshi Hamada, Osaka-shi (JP); Mikihiro Noma, Osaka-shi (JP)

(72) Inventors: Masashi Mayumi, Osaka-shi (JP); Akinori Kubota, Osaka-shi (JP); Hiroshi Hamada, Osaka-shi (JP); Mikihiro Noma, Osaka-shi (JP)

(21) Appl. No.: 13/820,603

(22) PCT Filed: Sep. 6, 2011
(86) PCT No.: PCT/JP2011/070204

§ 371 Date: Mar. 4, 2013

(30) Foreign Application Priority Data
Sep. 13, 2010 (JP) 2010-204607

(51) Int. Cl. G02F 1/133

(52) U.S. Cl. CPC G02F 1/13306
USPC 349/12

(57) ABSTRACT

A display device includes a display panel, a touch panel arranged on a display surface side of the display panel, a switching liquid crystal panel including a parallax barrier that enables three-dimension display, a common board that is commonly used as a base board of the touch panel and a base board of the switching liquid crystal panel, a plurality of electrodes provided on the common board and used for the touch panel and the switching liquid crystal panel, and a drive circuit configured to apply a synthesized signal to some of the electrodes. The synthesized signal is configured by synthesizing a touch panel drive signal and a switching liquid crystal drive signal.

### TECHNICAL FIELD

The present invention relates to a drive circuit of a display device, a display device, and a method of driving a display device. Especially, the present invention relates to a technology related to drive signals supplied to a touch panel and a parallax barrier in a display device including the touch panel and the parallax barrier.

### BACKGROUND ART

A display device including a display panel such as a liquid crystal panel is used for a portable terminal device such as a mobile phone and PDA or an electronic device such as a computer and a television. A parallax barrier is applied to such a display device to display a stereoscopic image. Using a parallax barrier, each of a left eye and a right eye sees a different image and human beings sense a stereoscopic image due to binocular parallax.
Patent Document 1 discloses one example of such a display device having a function of displaying stereoscopic images.
Patent Document 1: Japanese Unexamined Patent Application Publication No. 2004-272354

### Problem to be Solved by the Invention

The display device disclosed in Patent Document 1 includes a touch panel, a display panel such as a liquid crystal panel and a layer of switching liquid crystal (parallax barrier). Pixels for a right eye and pixels for a left eye are displayed on the display panel, and an observer can see the pixels for a right eye with his/her right eye and see the pixels for a left eye with his/her left eye through slits formed in the layer of switching liquid crystal. Accordingly, the observer can see a stereoscopic image caused by the binocular parallax.

The number of components is increased and a thickness and a weight of a whole device are also increased in the display device that displays stereoscopic images compared to a display device that displays only two-dimensional images. The display device including an input device such as a touch panel is further increased in its thickness and weight. The display device including a touch panel and having the function of displaying stereoscopic images is required to be reduced in thickness and weight. To achieve this, the touch panel and the parallax barrier may be commonly and integrally formed on one common board, and electrodes are mounted on the common board and the touch panel drive signals and the switching liquid crystal drive signals are supplied to the electrodes. In such a configuration, it is desired that the touch panel drive signals and the switching liquid crystal drive signals are supplied to the common board effectively.

### DISCLOSURE OF THE PRESENT INVENTION

The present invention was accomplished in view of the foregoing circumstances. An object of the present invention is to provide a technology that provides a common board to which a touch panel drive signal and a switching liquid crystal drive signal are effectively supplied.

### Means for Solving the Problem

To solve the above problem, a drive circuit of a display device according to the present technology drives the display device including a display panel, a touch panel provided on a display surface side of the display panel, and a parallax barrier configured with a switching liquid crystal panel that enables three-dimensional display. The display device includes a common board that is commonly used as a base board of the touch panel and one of two base boards of the switching liquid crystal panel, and further includes a plurality of electrodes used for the touch panel and the switching liquid crystal panel. The drive circuit is configured to apply a synthesized signal to some of the electrodes, and the synthesized signal is configured by synthesizing a touch panel drive signal and a switching liquid crystal drive signal.

With this configuration, the synthesized signal that is configured by synthesizing the touch panel drive signal and the switching liquid crystal drive signal is applied to some of the plurality of electrodes provided on the common board. According to a selection signal, the drive signal is switched between the touch panel drive signal and the switching liquid crystal drive signal and sent to a common electrode. Therefore, the touch panel drive signal and the switching liquid crystal drive signal are effectively sent to the common board.

In the above configuration, the synthesized signal may be configured by combining the touch panel drive signal and the switching liquid crystal drive signal.

The touch panel drive signal may include an active period and a non-active period, and a level of the touch panel drive signal during the non-active period may be switched alternately between a high level and a low level every non-active period to generate the synthesized signal.

The synthesized signal may include the touch panel drive signal and the switching liquid crystal drive signal that are switched therebetween with time-sharing. When the touch panel drive signal and the switching liquid crystal drive signal are switched therebetween with time-sharing, the synthesized signal may have a signal level set to a predetermined one of a high level or a low level just before starting of the touch panel drive signal.

The drive circuit may further include a synthesized signal generator configured to generate the synthesized signal.

The switching liquid crystal drive signal may have a pair of rectangular waveforms each of which has a same amplitude and an opposite phase.

A drive circuit of a display device of the present technology drives a display device including a display panel, a touch panel provided on a display surface side of the display panel, and a parallax barrier configured with a switching liquid crystal panel that enables three-dimensional display. The display device includes a common board that is commonly used as a base board of the touch panel and one of two base boards of the switching liquid crystal panel, and further includes a plurality of touch panel electrodes and a plurality of switching liquid crystal electrodes provided on a same plane surface of the common board. The drive circuit is configured to apply a touch panel drive signal to the touch panel electrodes, and apply a switching liquid crystal drive signal to the switching liquid crystal electrodes.

With this configuration, the touch panel drive signal is applied to the touch panel electrodes provided on the same plane surface of the common board and the switching liquid crystal drive signal is sent to the switching liquid crystal electrodes provided on the same plane surface of the common board. Therefore, the touch panel drive signal and the switching liquid crystal drive signal are effectively sent to the common board.

In the above configuration, the switching liquid crystal drive signal may preferably have a positive and negative symmetrical rectangular waveform.

The touch panel may be sensed in response to the touch panel drive signal at a sensing cycle, and the sensing cycle may be set to be an odd multiple of a half-cycle of the switching liquid crystal signal.

The touch panel drive signal and the switching liquid crystal drive signal may be synchronous with each other. The touch panel drive signal may be generated in response to a rising edge or a dropping edge of the switching liquid crystal drive signal. In synchronous with starting or ending of the touch panel drive signal, the level of the switching liquid crystal drive signal may be switched alternately between the high level and the low level or a polarity of the switching liquid crystal drive signal may be reversed between a positive polarity and a negative polarity.

The drive circuit may further include a touch panel controller configured to generate the touch panel drive signal for driving the touch panel and a selection signal generator configured to generate a selection signal for switching between the touch panel drive signal and the switching liquid crystal drive signal. The touch panel drive signal may be configured with a predetermined number of pulses. The common board may include a common electrode to which the touch panel drive signal and the switching liquid crystal drive signal are sent. The synthesized signal generator may receive the touch panel drive signal and the switching liquid crystal drive signal, and switch between the touch panel drive signal and the switching liquid crystal drive signal in response to the selection signal and generate the synthesized signal, and send the synthesized signal to the common electrode.

The selection signal generated by the selection signal generator may switch from the switching liquid crystal drive signal to the touch panel drive signal in response to rising of an initial pulse included in the touch panel drive signal, and thereafter switch from the touch panel drive signal to the switching liquid crystal drive signal in response to finishing of counting the predetermined pulses.

With this configuration, the selection signal is easily generated in response to the rising of the initial pulse of the touch panel drive signal.

The selection signal generator may generate the selection signal based on a number of pulses of the touch panel drive signal, a generation cycle of the touch panel drive signal, and a number of generation times of the touch panel drive signal every predetermined period. The selection signal generator may generate the switching liquid crystal drive signal based on the generated selection signal. The selection signal generator may send the generated switching liquid crystal drive signal to the synthesized signal generator.

With this configuration, the selection signal can be generated separately from the touch panel drive signal, and therefore, the touch panel drive signal is sent to the common electrode with a complete waveform. Also, the predetermined period may be a frame cycle, and the selection signal generator may restart generating the selection signal every frame cycle. Accordingly, the timing of the touch panel drive signal is precisely controlled.

The touch panel controller may control a sensing operation of the touch panel by a control signal, and the selection signal generator may start generating the selection signal in response to a vertical synchronous signal as a reference signal. The selection signal generator may generate the selection signal based on the vertical synchronous signal, a number of pulses of the touch panel drive signal, a generation cycle of the touch panel drive signal, and a number of generation times of the touch panel drive signal every predetermined period. The selection signal generator may send the selection signal to the synthesized signal generator and send the selection signal to the touch panel controller as the control signal.

With this configuration, with control of the touch panel controller, the switching liquid drive signal and the touch panel drive signal that are not synchronous with each other are precisely switched therebetween to be sent to each common electrode. The predetermined period may be a frame cycle.

The touch panel drive signal may have a minimum pulse width of 100 micro seconds or less, and the switching liquid crystal drive signal may have a pulse width of 1 milliseconds or more.

The touch panel drive signal may have a voltage equal to or less than a voltage of the switching liquid crystal drive signal.

A display device includes any one of the above described drive circuits. The display panel may be a liquid crystal display panel using liquid crystals.

Such a display device is applied to various uses such as a mobile phone, a smart phone, a portable game machine, a notebook computer, a desktop of a personal computer or a television device as a liquid crystal display device, and especially appropriate for a display screen of various sizes.

In a method of driving a display device according to the present technology, the display device includes a display panel, a touch panel provided on a display surface side of the display panel, and a parallax barrier configured with a switching liquid crystal panel that enables three-dimensional display. The display device further includes a common board that is commonly used as a base board of the touch panel and one of two base boards of the switching liquid crystal panel and further includes a plurality of electrodes used for the touch panel and the switching liquid crystal panel. The method includes synthesizing a touch panel drive signal that drives the touch panel and a switching liquid crystal drive signal that drives the switching liquid crystal panel to generate a synthesized signal, and applying the synthesized signal to some of the plurality of electrodes.

With this configuration, in the synthesizing, the synthesized signal is generated by combining the touch panel drive signal and the switching liquid crystal drive signal. Instead, in the synthesizing, the synthesized signal is generated by switching between the touch panel drive signal and the switching liquid crystal drive signal with time-sharing.

In a method of driving a display device according to the present technology, the display device includes a display panel, a touch panel provided on a display surface side of the display panel, and a parallax barrier configured with a switching liquid crystal panel that enables three-dimensional display. The display device further includes a common board that is commonly used as a base board of the touch panel and one of two base boards of the switching liquid crystal panel, and further includes a touch panel electrode and a switching liquid crystal electrode provided on a same plane surface of the common board. The method includes a first application process in which a touch panel drive signal that drives the touch panel is applied to the touch panel electrode, and a second application process in which a switching liquid crystal drive signal that drives the switching liquid crystal panel to the switching liquid crystal electrode.

### Advantageous Effect of the Invention

According to the present invention, a touch panel drive signal and a switching liquid crystal drive signal are effectively supplied to a common electrode.

### BRIEF DESCRIPTION OF THE DRAWINGS

FIG. 1 is a cross-sectional view illustrating a general construction of a display device according to a first embodiment.

FIG. 2 is a plan view typically illustrating electrodes mounted on a common board according to the first embodiment.

FIG. 3 is a plan view typically illustrating a second switching liquid crystal panel electrode included in the display device of FIG. 1.

FIG. 4 is a plan view typically illustrating a second touch panel electrode.

FIG. 5 is a block diagram illustrating a general construction for generation of a common electrode signal according to the first embodiment.

FIG. 6 is a timing chart generally illustrating signals of each electrode according to the first embodiment.

FIG. 7 is a timing chart generally illustrating a selection signal generation circuit according to the first embodiment.

FIG. 8 is a timing chart generally illustrating generation of a common electrode signal according to the first embodiment.

FIG. 9 is a block diagram generally illustrating a construction for generation of a common electrode signal according to a second embodiment.

FIG. 10 is a block diagram generally illustrating a selection signal generation circuit according to a second embodiment.

FIG. 11 is a timing chart generally illustrating generation of a common electrode signal according to the second embodiment.

FIG. 12 is a block diagram generally illustrating a construction for generation of a common electrode signal according to a third embodiment.

FIG. 13 is a block diagram generally illustrating a selection signal generation circuit according to the third embodiment.

FIG. 14 is a timing chart generally illustrating generation of a common electrode signal according to the third embodiment.

FIG. 15 is a plan view typically illustrating electrodes mounted on a common board according to a fourth embodiment.

FIG. 16 is a timing chart generally illustrating signals of each electrode according to the fourth embodiment.

FIG. 17 is a timing chart generally illustrating another common electrode signal.

FIG. 18 is a timing chart generally illustrating another switching liquid crystal drive signal.

### MODES FOR CARRYING OUT THE INVENTION

### First Embodiment

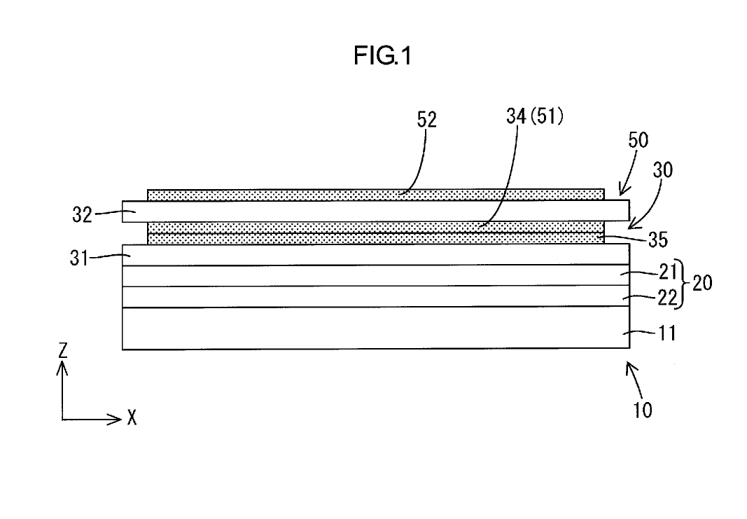

A first embodiment will be explained with reference to FIGS. 1 to 7. In the first embodiment, a liquid crystal display device 10 (display device) will be described as an example. The liquid crystal display device 10 is used as an information display element included in various electronic devices such as a portable information terminal, a mobile phone, a notebook computer, a portable game machine (not illustrated). An X-axis, a Y-axis and a Z-axis are described in a part of some drawings. A long-side of the liquid crystal display device 10 corresponds to the X-axis and a short-side thereof corresponds to the Y-axis. The up-down direction in FIG. 1 corresponds to the Z-axis (a front-rear direction, a direction vertical to a screen), and an upper side in FIG. 1 is a front-surface side and a lower side in FIG. 1 is a rear-surface side.

1. Configuration of Liquid Crystal Display Device

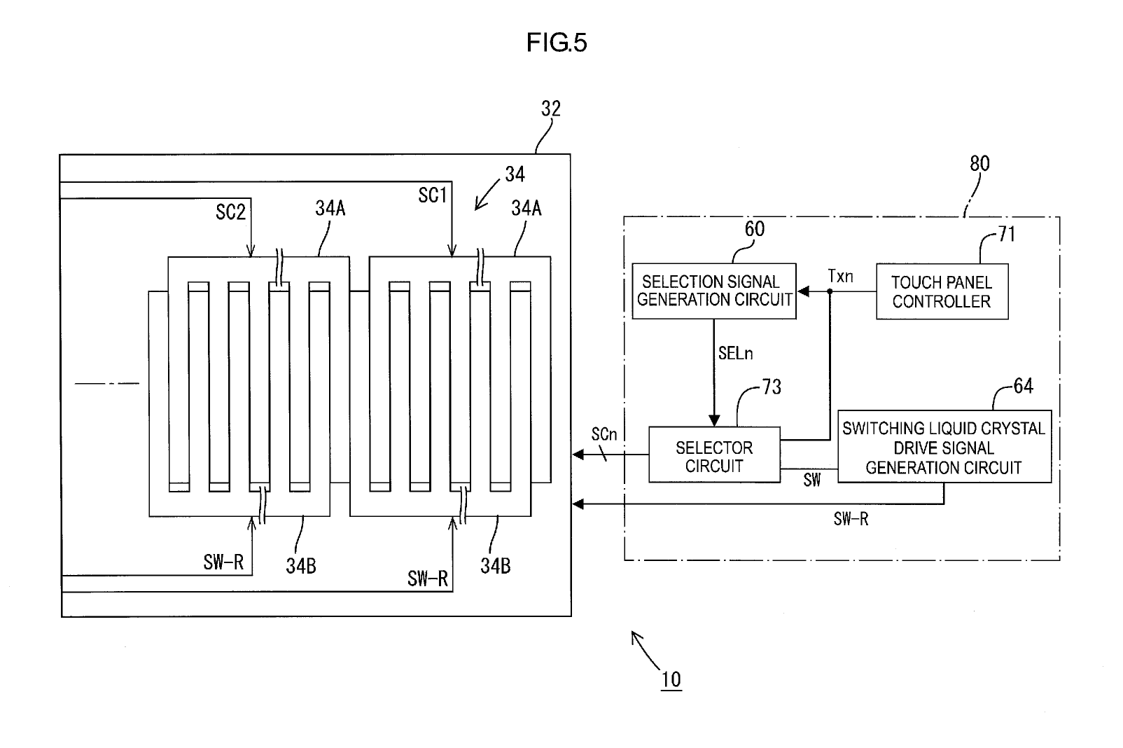

The liquid crystal display device 10 has a landscape quadrangular shape (rectangular shape) as a whole. As illustrated in FIG. 1, the liquid crystal display device 10 includes a backlight device 11, a liquid crystal panel 20 (a display panel), a switching crystal liquid panel 3, a touch panel 50, and a drive circuit 80 (see FIG. 5). The liquid crystal panel 20, the switching liquid crystal panel 30 and the touch panel 50 are laminated on the backlight device 11 in this order. The touch panel 50 and the switching liquid crystal panel 30 are provided on a display surface side of the liquid crystal display panel 20. The liquid crystal display panel 20, the switching liquid crystal panel 30 and the touch panel 50 are connected to the drive circuit 80 of the liquid crystal display device 10 via a flexible board (not illustrated), for example.

The backlight device 11 includes a chassis and light sources (for example, cold cathode tubes or LEDs (not illustrated)). The chassis is formed in substantially a box shape having an opening that is open to a front-surface side (a liquid crystal display panel 20 side) and the light sources, a light guide plate, a directivity control film, a diffuser sheet, and a reflection sheet are housed in the chassis. The backlight device 11 exits light toward the liquid crystal display panel 20. The backlight device 11 includes an optical member (not illustrated) that is arranged to cover the opening of the chassis. The optical member converts light emitted from the light sources to planar light.

The liquid crystal display panel 20 includes a pair of transparent (highly capable of light transmission) glass substrates 21, 22 and a liquid crystal layer (not illustrated) containing liquid crystal molecules that changes its optical property according to impressing of an electric field. The liquid crystal layer is provided between the pair of transparent glass substrates 21, 22. The transparent glass substrates 21, 22 are bonded together with a sealing agent with ensuring a gap corresponding to a thickness of the liquid crystal layer.

The transparent glass substrate 21 that is provided on a front-surface side (au upper side in FIG. 1) is a CF board 21 and the transparent glass substrate 22 that is provided on a rear-surface side is a TFT board 22 (an element board). A plurality of TFTs (thin film transistor) and pixel electrodes are arranged on an inner surface (a surface close to the liquid crystal layer, a surface facing the CF board 21) of the TFT board 22 (not illustrated). The TFT is a switching component that drives liquid crystals for every pixel. Source lines and gate lines that are arranged in a grid pattern are provided to surround each of the TFTs and the pixel electrodes. The gate lines and the source lines are connected to gate electrodes and source electrodes of the TFTs, respectively, and the pixel electrodes are connected to drain electrodes of the TFTs. Each of the pixel electrodes is a transparent electrode formed of ITO (Indium Tin Oxide) or IZO (Indium Zinc Oxide) and the like.

Color filters having color sections such as R (red), G (green) and B (blue) color sections arranged corresponding to each pixel are provided on the CF board 21. A light blocking layer (a black matrix) is formed between the color sections of the color filter to prevent mixing of colors. Counter electrodes are provided on surfaces of the color filter and the light blocking layer so as to face the pixel electrodes on the TFT board 22. An alignment film is provided on an inner surface of each of the boards 21, 22 to arrange an alignment of liquid crystal molecules contained in the liquid crystal layer. A polarizing plate (not illustrated) is provided on an outer surface of each board 21, 22.

The switching liquid crystal panel 30 and the touch panel 50 are integrally provided on a front surface side (an upper side in FIG. 1) of the liquid crystal display panel 20.

The switching liquid crystal panel 30 is arranged in adjacent to the liquid crystal display panel 20 and capable of switching a display mode between a two-dimensional display mode and a three-dimensional display mode. The switching liquid crystal panel 30 includes a transparent (capable of light transmission) glass boards 31, 32, a liquid crystal layer (not illustrated) that is provided between the boards 31, 32, and a polarizing plate provided on an outer surface of the liquid crystal layer. The glass board 32 that is provided away from the liquid crystal display panel 20 configures a part of the touch panel 50 and is used commonly for the switching liquid crystal panel 30 and the touch panel 50. Therefore, the glass board 32 is referred to as a common board.

The switching liquid crystal panel 30 includes switching liquid crystal panel electrodes 34, 35 that apply a voltage to the liquid crystal layer arranged between the boards 31 and 32. Each of the electrodes 34, 35 is a transparent electrode and extends in a different direction.

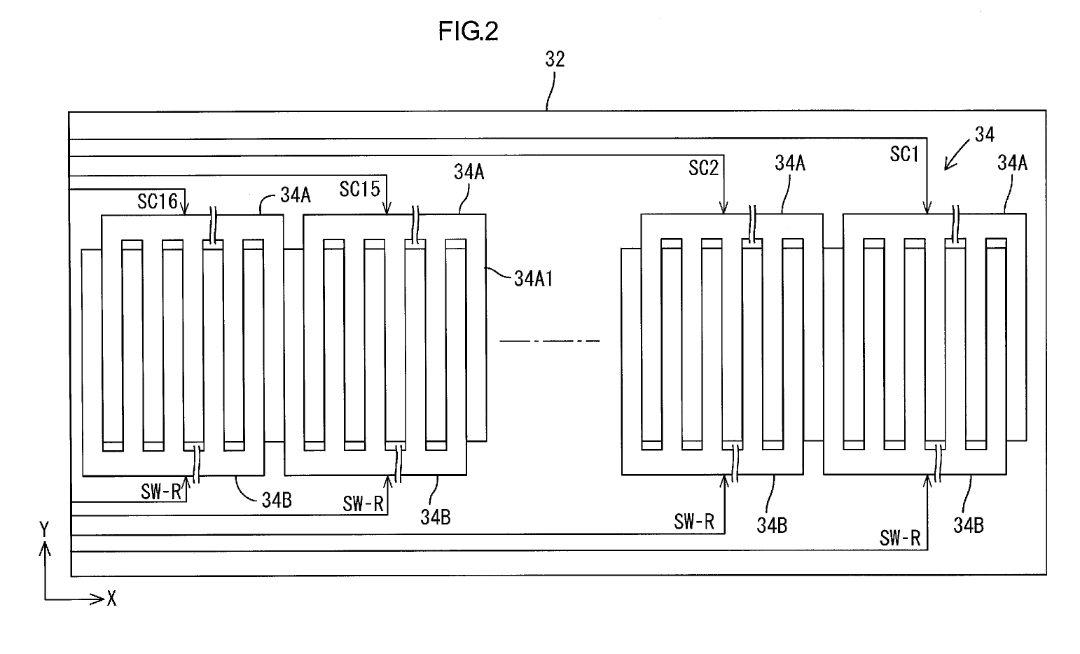

The first switching liquid crystal panel electrode 34 that is provided close to the touch panel 50 and provided on the common board 32 extends in the Y-axis direction (along one side of the liquid crystal display device 10), as illustrated in FIG. 2. Specifically, the first switching liquid crystal panel electrode 34 includes a plurality pairs of comb-shaped electrodes 34A, 34B that are arranged in the X-axis direction. In this embodiment, sixteen pairs of electrodes 23A, 34B are arranged. In one pair of the electrodes 34A, 34B, an extending portion 34B1 (extending in the Y-axis direction) of the electrode 34B is provided between extending portions 34A1 (extending in the Y-axis direction) of the electrode 34A. Each of the electrodes 34A, 34B is configured with twenty five extending portions 34A1, 34B1.

The first switching liquid crystal panel electrode 34 configures apart of a transparent electrode of the touch panel 50. The first switching liquid crystal panel electrode 34 is used commonly for the switching liquid crystal panel 30 and the touch panel 50 and may be referred to as a common electrode 34.

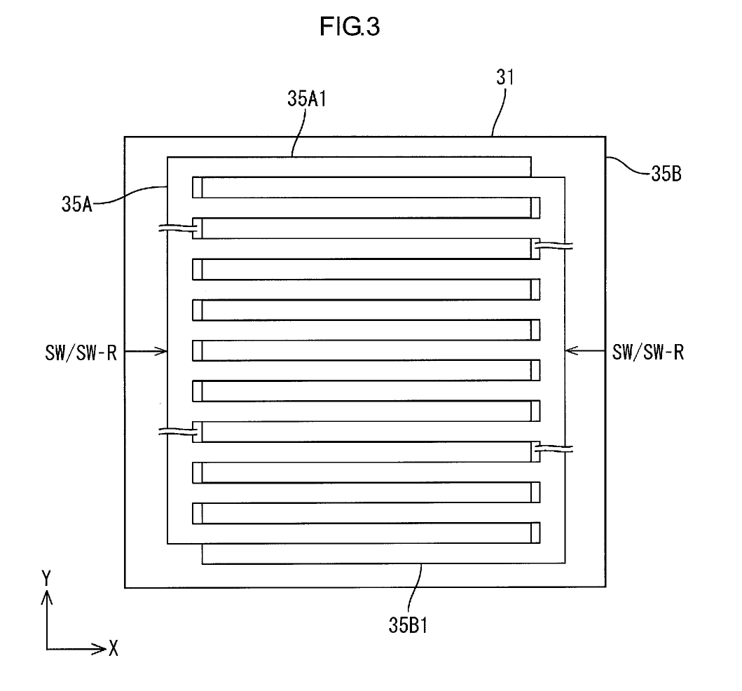

As illustrated in FIG. 3, a second switching liquid crystal panel electrode 35 that is provided on the glass board 31 and close to the liquid crystal display panel 20 extends in the X-axis direction. Specifically, the second switching liquid crystal panel electrode 35 includes a plurality pairs of comb-shaped electrodes 35A, 35B that are arranged in the X-axis direction. In one pair of the electrodes 35A, 35B, an extending portion 35B1 (extending in the X-axis direction) of the electrode 35B is provided between extending portions 35A1 (extending in the X-axis direction) of the electrode 35A. A part of the pair of electrodes 35A, 35B is illustrated in FIG. 3.

A switching liquid crystal drive signal SW that is a parallax barrier drive signal (having a positive and negative symmetrical rectangular waveform in this embodiment) is applied to the electrode 34A of the electrodes 34A and 34B included in the first switching liquid crystal panel electrode 34, and the electrode 34B and the second switching liquid crystal panel electrodes 35A, 35B are grounded. Then, light (that is exited from the backlight device 11 and transmitted through the liquid crystal display panel 20) is transmitted only through the portions of the switching liquid crystal panel 30 corresponding to the extending portions 34A1 of the electrode 34A. Namely, the switching liquid crystal panel 30 is a normally white type. Accordingly, in the liquid crystal display panel 20, one group of pixels can be seen by a right eye and another group of pixels can be seen by a left eye. The switching liquid crystal panel 30 functions as a parallax barrier for a landscape position (a horizontal position) and this enables three-dimensional display.

A switching liquid crystal drive signal SW (having a positive and negative symmetrical rectangular waveform in this embodiment) is applied to one of the electrodes 35A, 35B of the second switching liquid crystal display panel electrode 35, for example, the electrode 35A, and the electrode 35B and the first switching liquid crystal panel electrodes 34A, 34B are grounded. Then, the light (that is exited from the backlight device 11 and transmitted through the liquid crystal display panel 20) is transmitted only through the portions of the switching liquid crystal panel 30 corresponding to the extending portions 35A1 of the electrode 35A. Accordingly, in the liquid crystal display panel 20, one group of pixels can be seen by a right eye and another group of pixels can be seen by a left eye. The switching liquid crystal panel 30 functions as a parallax barrier for a portrait position (a vertical position) and this enables three-dimensional display.

In the present embodiment, the liquid crystal display device 10 includes two types of the switching liquid crystal panel electrodes 34, 35 that extend indifferent directions. Therefore, a parallax barrier is created in the long-side direction and the short-side direction of the liquid crystal display device 10, and the three-dimensional display is enabled in both cases in which the display device 10 is in the vertical position and in the horizontal position.

Pixels for a right eye and pixels for a left eye are displayed on the liquid crystal display panel 20. A user of the liquid crystal display device 10 can see the right eye pixels with his/her right eye and see the left eye pixels with his/her left eye via the light transmission portions formed on the switching liquid crystal panel 30. A predetermined AC voltage is not applied to the first switching liquid crystal panel electrode 34 and the second switching liquid crystal panel electrode 35, and accordingly the light transmission portions are formed on an almost entire area of the switching liquid crystal display panel 30. This enables the two-dimensional display.

The AC voltage is obtained by generating a positive and negative symmetrical rectangular waveform having approximately ±5V or generating a unipolar rectangular waveform with a reverse phase of approximately 0/5V. In the first embodiment, a unipolar rectangular waveform with a reverse phase of approximately 0/5V is preferably generated. In this method, if an AC voltage with a same phase is applied to each of the electrodes 34, 35 holding the switching liquid crystal layer therebetween, any voltage is applied to the liquid crystal layer, and if a voltage with a reverse phase is applied to the electrodes 34, 35, an AC voltage is applied to the liquid crystal layer and this changes transmission of the liquid crystal layer.

In the present embodiment, a normally white mode in which light is transmitted through the liquid crystal panel if no AC voltage is applied to the electrodes is used as an operation mode of the switching liquid crystal display panel 30. However, a normally black mode in which light is transmitted through the switching liquid crystal panel if an AC voltage is applied to the electrodes may be used.

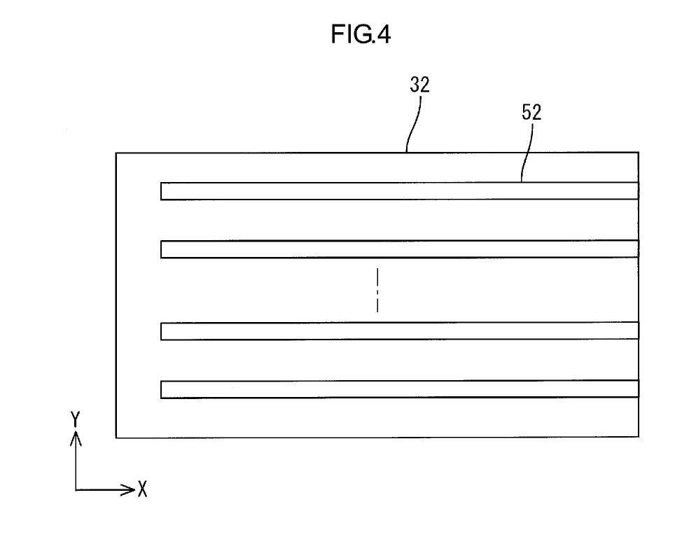

The touch panel 50 includes the common board 32 and touch panel electrodes 51, 52 each of which is a transparent electrode and provided on a front surface and a rear surface of the common board 32. Specifically, the common electrode 34 provided on the lower surface of the common board 32 and extending in the Y-axis direction is used as the first touch panel electrode 51. As illustrated in FIG. 4, the second touch panel electrode 52 is provided on the upper surface of the common board 32 and extends in the X-axis direction (a direction perpendicular to the first touch panel electrode 51).

Data (for example, coordinate data on the touch panel 50) is input via the touch panel 50 according to change in electrostatic capacity between the first touch panel electrode 51 (the common electrode 34) and the second touch panel electrode 52 that is generated by touching of the surface of the touch panel 50 with a finger. The touch panel 50 of the present embodiment is a touch panel of a mutual capacitance sensing method. For example, if a user touches the touch panel 50 with his/her finger while a touch panel drive signal Txn configured with a certain number of (four) pulses is sequentially applied to the first touch panel electrode 34A, an electrostatic capacity within a detection circuit loop changes. It is determined at which one of crossing points between the first touch panel electrode 34A and the second touch panel transparent electrode 52 the change in the electrostatic capacity occurs. This determination is made based on a waveform of a current that flows via the second touch panel transparent electrode 52 and a timing of application of the touch panel drive signal Txn.

In the present embodiment, the common board 32 is used commonly in the touch panel 50 and the switching liquid crystal panel 30. Both of the touch panel 50 and the switching liquid crystal panel 30 require a transparent electrode extending in the Y-axis direction. Accordingly, the transparent electrode (34A or 34B) extending in the Y-axis direction is commonly used for the both panels 30, 50.

In the common electrode 34 of the present embodiment, an interval between the adjacent extending portions 34A1 (that is a minimum interval of a light blocking barrier formed on the switching liquid crystal panel 30) is set to be 200 μm. If the electrode is used as the transparent electrode 51 for the touch panel 50, for example, twenty five extending portions 34A1 are used as one set. Resolution of the touch panel 50 in the X-axis direction is set to be 5 mm. The number of the extending portions 34A1 included in the one set may be altered if necessary, and an interval between the extending portions 34A1 may be altered if necessary.

2. Electric Configuration Relating to Generation of Common Electrode Signal

Next, an electric configuration relating to generation of a common electrode signal (one of examples of a synthesized signal) SCn supplied to the common electrode 34 will be explained with reference to FIGS. 5 to 8.

As illustrated in FIG. 5, the liquid crystal display device 10 includes the drive circuit 80 as a circuit for generating a common electrode signal SCn. The drive circuit 80 includes a selection signal generation circuit 60, a touch panel controller 71, a switching liquid crystal drive signal generation circuit 72, and a selector circuit (one of examples of a synthesized signal generator) 73. The drive circuit 80 further includes a display panel driver (not illustrated) that drives the liquid crystal display panel 20 and a backlight driver (not illustrated) that drives the backlight device 11.

Driving of the drive circuit 80 in the present embodiment will be explained. In the present embodiment, for example, sixteen common electrodes 34A are arranged on the common board 32, and common electrode signals (SC1 to SC16) are generated corresponding to each common electrode 34A.

In the present embodiment, the common electrode signal SCn that is generated by synthesizing the touch panel drive signal Txn and the switching liquid crystal drive signal SW is applied to apart of the electrodes 34A, 34B that are arranged on the lower surface of the common board 32, specifically to the electrodes 34A. In the present embodiment, all of the sixteen electrodes 34A are used as the common electrode 34A. However, this is not limited thereto. A part of the electrodes 34A may be used as the common electrode 23A according to the required number of switches of the touch panel 50. For example, eight out of sixteen electrodes 34A may be used as the common electrode 34A and the other eight electrodes 34A may be used as the electrode only for outputting the switching liquid crystal drive signal SW.

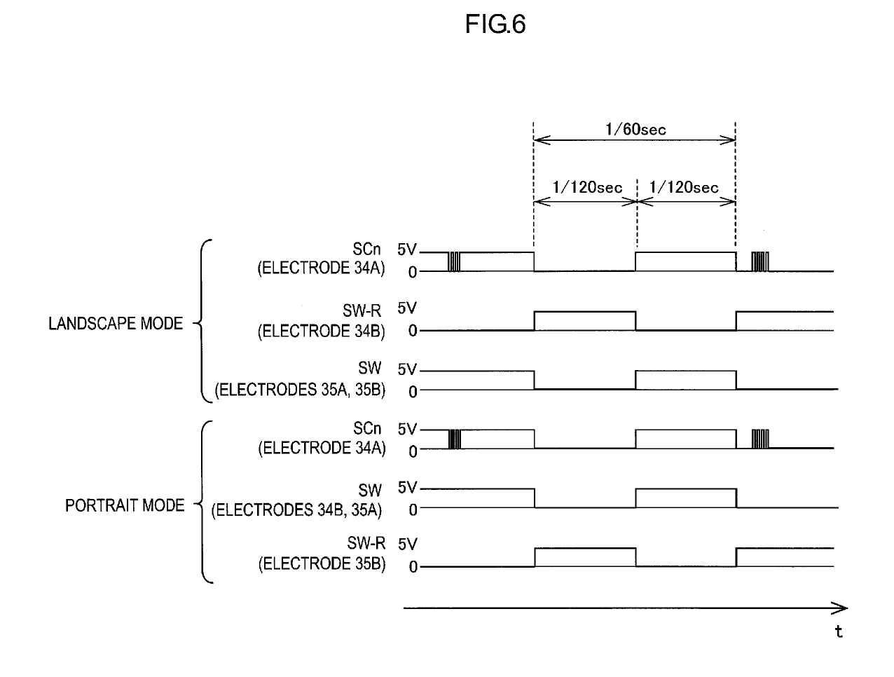

One example of a timing chart of a signal applied to each wiring is illustrated in FIG. 6. As illustrated in FIG. 6, in the landscape mode, the common electrode signal SCn is applied to the common electrode 34A and the electrode 34B receives the switching liquid crystal drive signal SW (hereinafter, referred to as a reverse phase switching liquid crystal drive signal SW-R) that has an amplitude same as the switching liquid crystal drive signal included in the common electrode signal SCn and has a rectangular waveform with a reverse phase. In this case, the switching liquid crystal drive signal SW has a rectangular waveform with a frequency of 60 Hz and a voltage of 5V. The switching liquid drive signal SW that is same as that applied to the electrode 34A is applied to the electrodes 35A, 35B. In case of FIG. 6, the parallax barrier is generated by the electrode 34B.

In the portrait mode (in the vertical position), the common electrode signal SCn is applied to the common electrode 34A and the reverse phase switching liquid crystal drive signal SW-R is applied to the electrode 35B. The switching liquid crystal drive signal SW same as that applied to the electrode 34A is applied to the electrodes 34A, 35A. In case of FIG. 6, the parallax barrier is generated by the electrode 35B.

The touch panel controller 71 generates a touch panel drive signal Txn at a predetermined cycle (hereinafter, referred to as a sensing cycle TSN) and supplies the touch panel drive signal Txn to the selection signal generation circuit 60 and the selector circuit 73. The touch panel 50 is driven in response to the touch panel drive signal Txn. The touch panel controller 71 generates the touch panel drive signal Txn including four pulses at the sensing interval TSN of substantially 1 ms. The touch panel 50 is sensed in response to each touch panel drive signal Txn at the sensing interval TSN. A frequency of each of the pulses is from several tens KHz to several hundreds KHz. If the frequency of each pulse is set to a hundred KHz, a signal period (a pulse width) of each touch panel drive signal Txn is approximately 40 μS. The touch panel drive signal Txn is supplied to the selection signal generation circuit 60 and the selector circuit 73 at a different timing.

A minimum pulse width of the touch panel drive signal Txn is preferably 100 microseconds or less. If the pulse width is greater than 100 microseconds, the timing of scanning is delayed and this deteriorates response of the touch panel 50.

A surface resistance value of an electrode material is selected such that a time constant of the common electrode of the switching liquid crystals is set to be a predetermined value or less according to the minimum pulse width of the touch panel drive signal Txn. The electrode to which only the switching liquid crystal drive signal SW is applied can have a time constant in a wide range. Therefore, the electrode to which only the switching liquid crystal drive signal SW is applied may have a surface resistance value higher than that of the common electrode. This improves transmission and visual quality of the panel.

A voltage of the touch panel drive signal Txn is preferably equal to or smaller than a voltage of the switching liquid crystal drive signal. The touch panel drive signal Txn and the switching liquid crystal drive signal SW are synthesized, and if the effective value of the touch panel drive signal Txn is too large, the operation of the switching liquid crystals is affected and cross talk frequently occurs between right-eye images and left-eye images in 3D display mode. This may deteriorate the display quality. In the present embodiment, the voltage (an absolute value) of each of the touch panel drive signal Txn and the switching liquid crystal drive signal is 5V.

The switching liquid crystal drive signal generation circuit (hereinafter, referred to as a SW signal generation circuit) 72 generates the switching liquid crystal drive signal SW of one frame cycle and sends the switching liquid crystal drive signal SW to the selector circuit 73. The frame frequency is 60 Hz. If the frequency of the switching liquid crystal drive signal SW is set to be equal to the frame frequency, the cycle of the switching liquid crystal drive signal SW is approximately 16.7 ms.

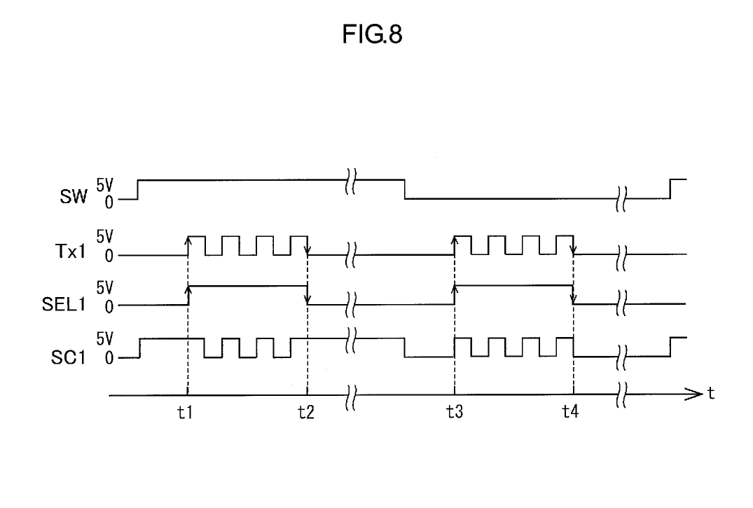

As illustrated in FIGS. 6 and 8, the switching liquid crystal drive signal SW is a pulse signal having a low level of 0V and a high level of 5V. The SW signal generation circuit 72 generates the reverse phase switching liquid crystal drive signal SW-R. The reverse switching liquid crystal drive signal SW-R is applied to each electrode 34B. Namely, the switching liquid crystal drive signal is configured with the switching liquid crystal drive signal SW and the reverse phase switching liquid crystal drive signal SW-R each of which has a rectangular waveform having a same amplitude and a reverse phase. The switching liquid crystal drive signal is thus configured such that the liquid crystals are usually driven with AC drive to less likely to cause deterioration of the liquid crystals.

The pulse width of the switching liquid crystal drive signal SW is preferably 1 ms and the cycle of the switching liquid crystal drive signal SW is preferably 2 ms or longer. This is determined by response speed of the liquid crystals. For example, if liquid crystals of TN method are used, the inductivity thereof becomes negative if the drive frequency is 1 KHz or greater and the liquid crystals will not be operated. The pulse width of the switching liquid crystal drive signal SW is set to the above value to sufficiently ensure the operation of the liquid crystals used for the switching liquid crystal panel 30.

The selector circuit 73 receives the touch panel drive signal Txn and the switching liquid crystal drive signal SW and switches between the touch panel drive signal TX and the switching liquid crystal drive signal SW in response to the selection signal SEL from the selection signal generation circuit 60 and generates the common electrode signal SCn. The selector circuit 73 supplies the common electrode signal SCn to the common electrode 34A.

In the present embodiment, the common electrode signal SCn is configured with the touch panel drive signal Txn and the switching liquid crystal drive signal SW that are switched from each other with time-sharing. The selector circuit 73 that generates the common electrode signals SC1 to SC6 may be provided for each of the common electrodes 34A.

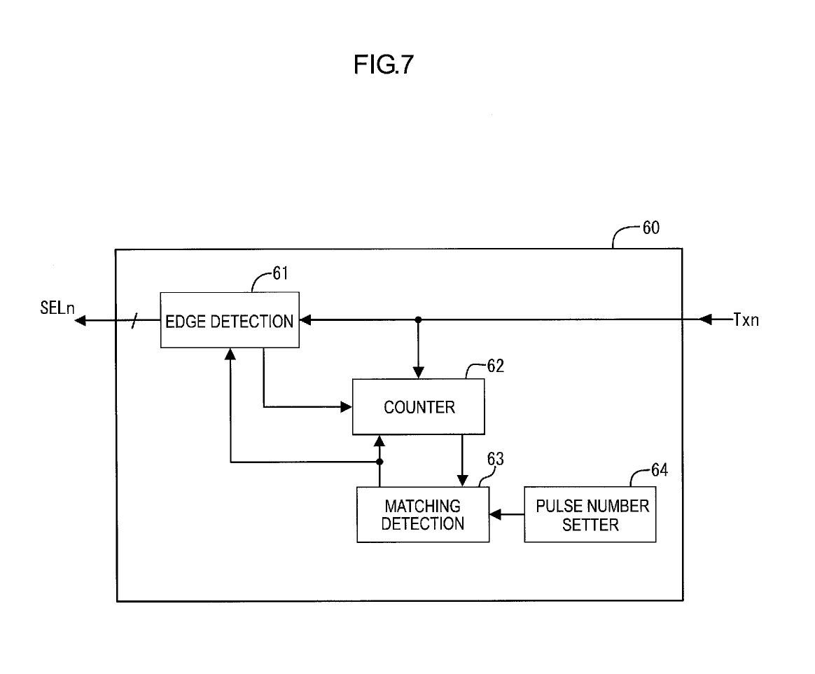

As illustrated in FIG. 7, the selection signal generation circuit 60 includes an edge detection circuit 61, a counter 62, a matching detection circuit 63, and a pulse number setter 64. The selection signal generation circuit 60 generates a selection signal SELn that causes switching between the touch panel drive signal Txn and the switching liquid crystal drive signal SW. More specifically, the selection signal generation circuit 60 switches the drive signal from the switching liquid crystal drive signal SW to the touch panel drive signal Txn in response to rising of an initial pulse of the touch panel drive signal Txn. Then, the selection signal generation circuit 60 generates a selection signal SELn that causes switching from the touch panel drive signal Txn to the switching liquid crystal drive signal SW, if the count number of pulses of the touch panel drive signal Txn reaches a predetermined number.

If an initial pulse of the touch panel drive signal Tx1 rises at a time t1 in FIG. 8, the edge detection circuit 61 detects the rising of the initial pulse and raises a level of the selection signal SEL1 from the low level (0V) to the high level (5V). Then, the selector circuit 73 receives the high-level selection signal SEL1 and switches the common electrode signal SC1 from the switching liquid crystal drive signal SW to the touch panel drive signal Tx1. The edge detection circuit 61 sends a signal that starts operation to the counter 62 when the initial pulse of the touch panel drive signal Tx1 rises up.

After the counter 62 of the selection signal generation circuit 60 starts to operate, the counter 62 counts the number of pulses of the touch panel drive signal Tx1 and sends the counted number to the matching detection circuit 63. The matching detection circuit 63 compares the counted number and a set value that is set to the pulse number setter 64 (a predetermined number of pulses of the touch panel drive signal Txn). If detecting that the counted number matches the set value (four) (at the time t2 in FIG. 8), the matching detection circuit 63 sends a matching signal to the edge detection circuit 61.

The edge detection circuit 61 lowers the level of the selection signal SEL1 from the high level to the low level in response to the matching signal. Then, the selector circuit 73 receives the low-level selection signal SEL1 and switches the common electrode signal SC1 from the touch panel drive signal Tx1 to the switching liquid crystal drive signal SW (see the time t2). The common electrode signals SC2 to SC16 are generated similarly.

The common electrode signal SC1 is switched at the time t1 and the time t2 in FIG. 8 when the switching liquid crystal drive signal SW is at the high level. The common electrode signal SC1 is switched at the time t3 and the time t4 in FIG. 8 when the switching liquid crystal drive signal SW is at the low level.

In the present embodiment, the display device includes the selection signal generation circuit 60 and the selector circuit 73. With this configuration, the common electrode signal SCn is switched between the switching liquid crystal drive signal SW and the touch panel drive signal Txn. Therefore, the switching liquid crystal drive signal SW and the touch panel drive signal Txn are effectively sent to the common electrode 34A. Using the rising of the initial pulse of the touch panel drive signal Txn, the selection signal SELn is easily generated.

### Second Embodiment

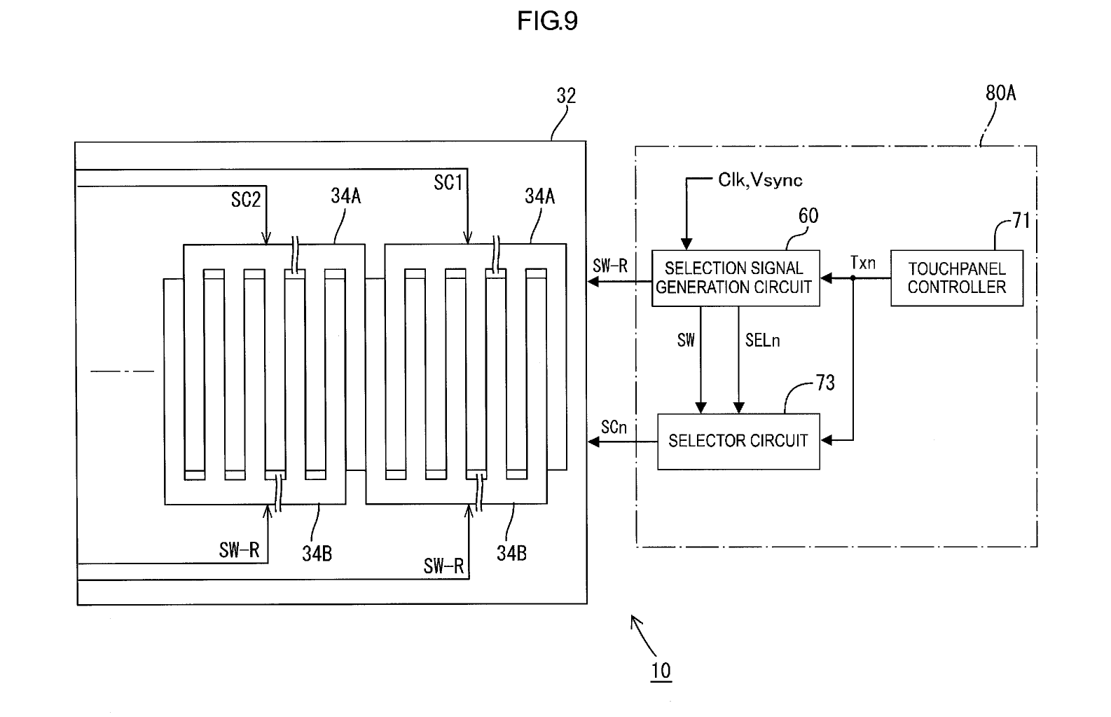

Next, a second embodiment will be explained with reference to FIGS. 9 to 11. In the second embodiment, a configuration relating to the generation of the common electrode signal SCn is different from that of the first embodiment. Specifically, a configuration of a selection signal generation circuit 60A of a drive circuit 80A of the second embodiment is different from that in the first embodiment. Same numerals or symbols are applied to components of the second embodiment same as those in the first embodiment and the components will not be explained. Only different features of the selection signal generation circuit will be explained.

The selection signal generation circuit 60A of the second embodiment generates the selection signal SELn based on the number of pulses of the touch panel drive signal Txn, a generation cycle of the touch panel drive signal Txn, and the number of generation times of the touch panel drive signal Txn in every predetermined period. The selection signal generation circuit 60A generates the switching liquid crystal drive signal SW based on the generated selection signal SELn and sends the generated switching liquid crystal drive signal SW to the selector circuit 73. The predetermined period is preferably a frame cycle and the selection signal generation circuit 60A restarts to generate the selection signal SELn at every frame.

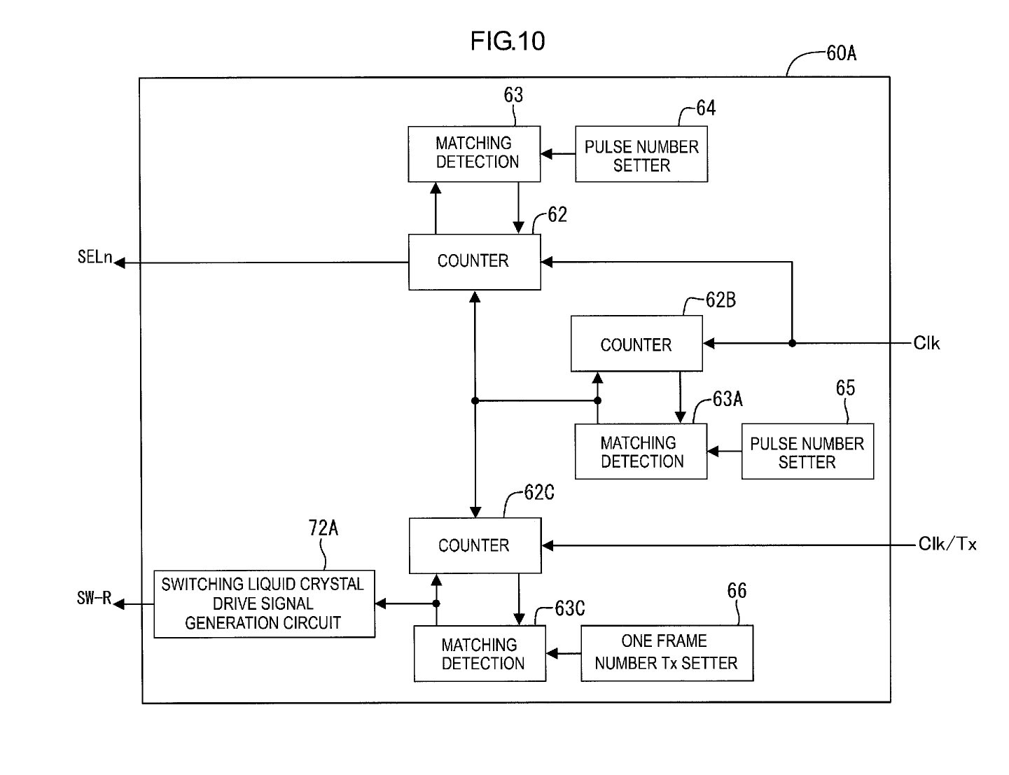

Specifically, as illustrated in FIG. 10, the selection signal generation circuit 60A includes first to third counters 62A, 62B, 62C, first to third matching detection circuit 63, 63A, 63B, a pulse number setter 64, a cycle setter 65, a one frame Tx number setter 66, and a SW signal generation circuit 72A.

For example, the pulse number setter 64 is set to be 4 as the number of pulses of the touch panel drive signal Txn. A clock number of a clock signal Clk corresponding to the generation period that is 4000 is set to the cycle setter 65 as the generation period of the touch panel drive signal Txn. The one frame Tx number setter 66 is set to 16 as the number of generation times of the touch panel drive signal Txn in every frame. Each of the set values is set according to usage conditions of the touch panel 50 and the touch panel controller 71 and may be altered if necessary. Each of the setters 64, 65, 66 is configured such that setting conditions may be changed by a register (not illustrated) included in the selection signal generation circuit 60A. Each of the setters 64, 65, 66 may be configured with a memory such as an EEPROM.

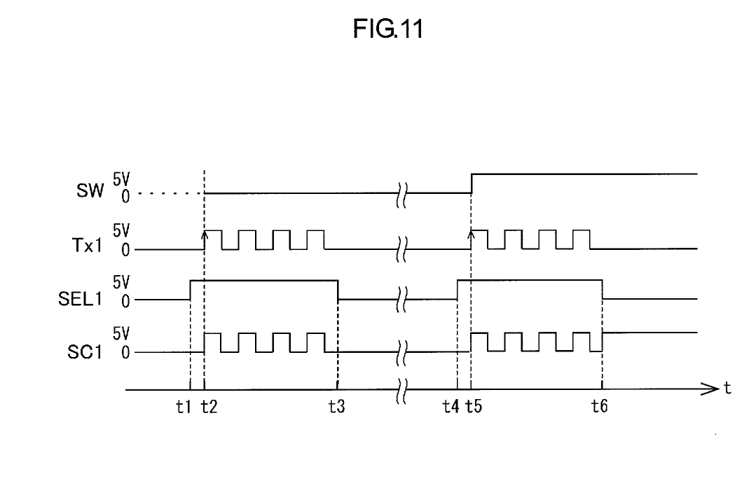

The first counter 62A raises the level of the selection signal SEL1 from the low level to the high level at the time t1 in FIG. 11 based on the number of pulses of the touch panel drive signal Txn, the generation cycle of the touch panel drive signal Txn and the number of generation times of the touch panel drive signal Txn in every frame. Specifically, the counter 62B counts the clock number until the time just before the rising of the touch panel drive signal Tx pulse based on the clock signal Clk from the touch panel 50. At the time t1, the value of the counter 62B matches the value of the matching detection circuit 65 (the previously set cycle).

At the time t1 in FIG. 11, the selector circuit 73 receives the high-level selection signal SEL1 and sets the level of the common electrode signal SC1 to the low level and sets the common electrode signal SC1 as the touch panel drive signal Tx1. When the common electrode signal SC1 is switched between the touch panel drive signal Tx1 and the switching liquid crystal drive signal SW with time-sharing, the signal level of the common electrode signal SC1 is set to a predetermined one of the high level or the low level just before the rising of the touch panel drive signal Tx1.

If the touch panel drive signal Tx1 rises at the time t2 at which predetermined time has passed from the time t1, the SW signal generation circuit 72A starts to generate the switching liquid crystal drive signal SW from the low level and sends the switching liquid crystal drive signal SW to the selector circuit 73. The SW signal generation circuit 72A generates and sends the reverse phase switching liquid crystal drive signal SW-R to each electrode 34B.

At time t3 in FIG. 11, a predetermined delay time has passed from the reception of the matching signal from the first matching detection circuit 63. At the time t3, the first counter 62A raises the level of the selection signal SEL1 from the high level to the low level. The selector circuit 73 receives the low-level selection signal SEL1 and switches the common electrode signal SC1 from the touch panel drive signal Tx1 to the switching liquid crystal drive signal SW. The predetermined time from the reception of the matching signal to the time t3 is determined by counting the clock number of the clock signal Clk having a cycle of 1 μs.

At time t4 in FIG. 11, a predetermined time has passed from the time t1 in FIG. 11. The level of the selection signal SEL1 rises from the low level to the high level at the time t4. It is determined whether the predetermined time has passed from the time t1 based on the clock signal Clk from the touch panel 50 similarly to the case of the time t1.

At the time t4 in FIG. 11, the selector circuit 73 receives the high-level selection signal SE1 and switches the common electrode signal SC1 from the switching liquid crystal drive signal SW to the touch panel drive signal Tx1. At time t5, a predetermined time has passed from the time t4 in FIG. 11. If the touch panel drive signal Tx1 rises at the time t5, the SW signal generation circuit 72A changes the level of the switching liquid crystal drive signal SW from the low level to the high level and sends the high-level switching liquid crystal drive signal SW to the selector circuit 73.

At time t6 in FIG. 11, a predetermined time has passed from the reception of the matching signal from the first matching detection circuit 63. At the time t6 in FIG. 11, the first counter 62A raises the level of the selection signal SEL1 from the high level to the low level similarly to the time t3 in FIG. 11. The selector circuit 73 receives the low-level selection signal SEL1 and switches the common electrode signal SC1 from the touch panel drive signal Tx1 to the switching liquid crystal drive signal SW.

In the second embodiment, the selection signal generation circuit 60A generates the selection signal SELn based on the number of pulses of the touch panel drive signal Txn, and the generation cycle of the touch panel drive signal Txn, and the number of generation times of the touch panel drive signal Txn at every period. The selection signal generation circuit 60A generates the switching liquid crystal drive signal SW based on the generated selection signal SELn and sends the generated switching liquid crystal drive signal SW to the selector circuit 73. This enables the selection signal SELx to be generated separately from the touch panel drive signal Txn and the touch panel drive signal Txn has a complete waveform and such a touch panel drive signal Txn is supplied to the common electrode 34A.

Because the generation of the selection signal SELn is restarted at every frame, the on-timing of the touch panel drive signal Txn is surely controlled. The touch panel drive signal Txn and the switching liquid crystal drive signal SW are synchronous with each other.

### Third Embodiment

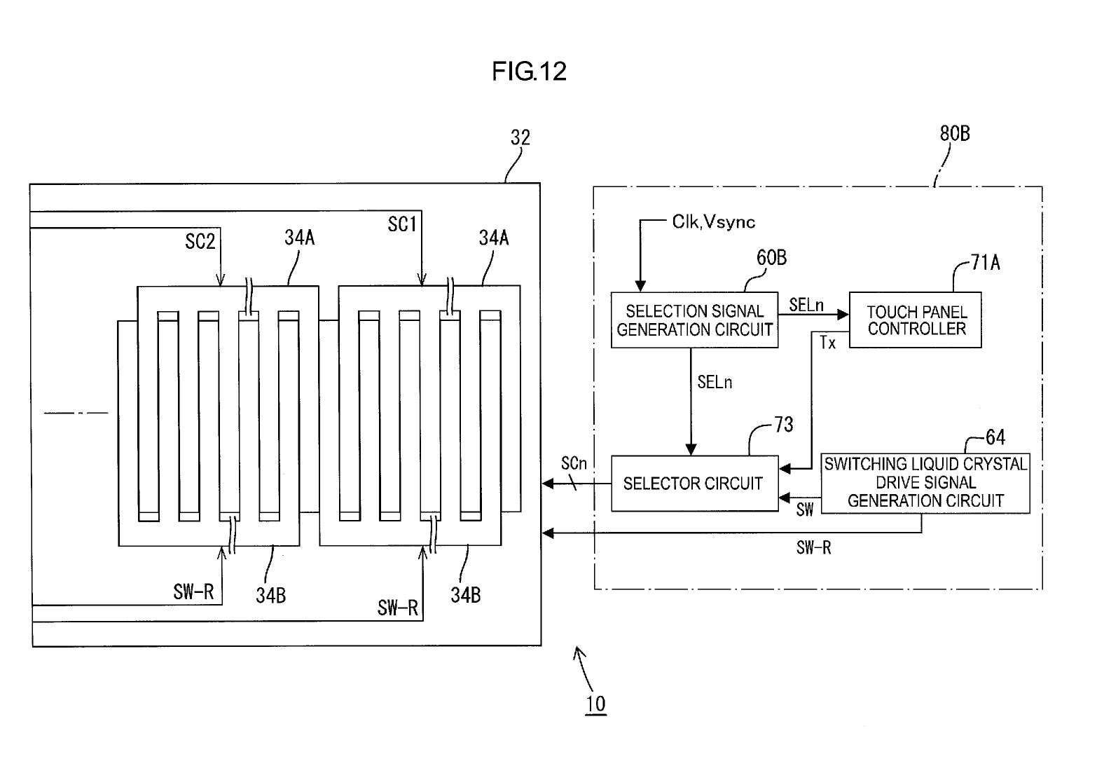

Next, a third embodiment will be explained with reference to FIGS. 12 to 14. In the third embodiment, a configuration relating to the generation of the common electrode signal SCn is different from that of the first embodiment and the second embodiment. Specifically, a configuration of a selection signal generation circuit 60B of a drive circuit 80B of the third embodiment is different from that in the first embodiment and the second embodiment. Same numerals or symbols are applied to components of the third embodiment same as those in the first embodiment and the second embodiment and the components will not be explained. Only different features of the selection signal generation circuit will be explained.

A touch panel controller 71A of the third embodiment controls a sensing operation of the touch panel 50 by a control signal. While waiting for the sensing operation, the touch panel controller 71A stops generating and outputting the touch panel drive signal Txn.

In response to a vertical synchronizing signal Vsync as a reference signal, a selection signal generation circuit 60B of the third embodiment starts generating the selection signal SELn. The selection signal generation circuit 60B generates the selection signal SELn based on the vertical synchronizing signal Vsync, the number of pulses of the touch panel drive signal, the generation cycle of the touch panel drive signal, and the number of generation times of the touch panel drive signal in every predetermined period. The selection signal generation circuit 60B sends the selection signal SELn to the selector circuit 73 and also sends the selection signal SELn to the touch panel controller 71A as the control signal. The predetermined period is preferably a frame cycle. The frame cycle is, for example, 1/120 sec (8.3 ms) and is equal to a cycle of the vertical synchronizing signal Vsync.

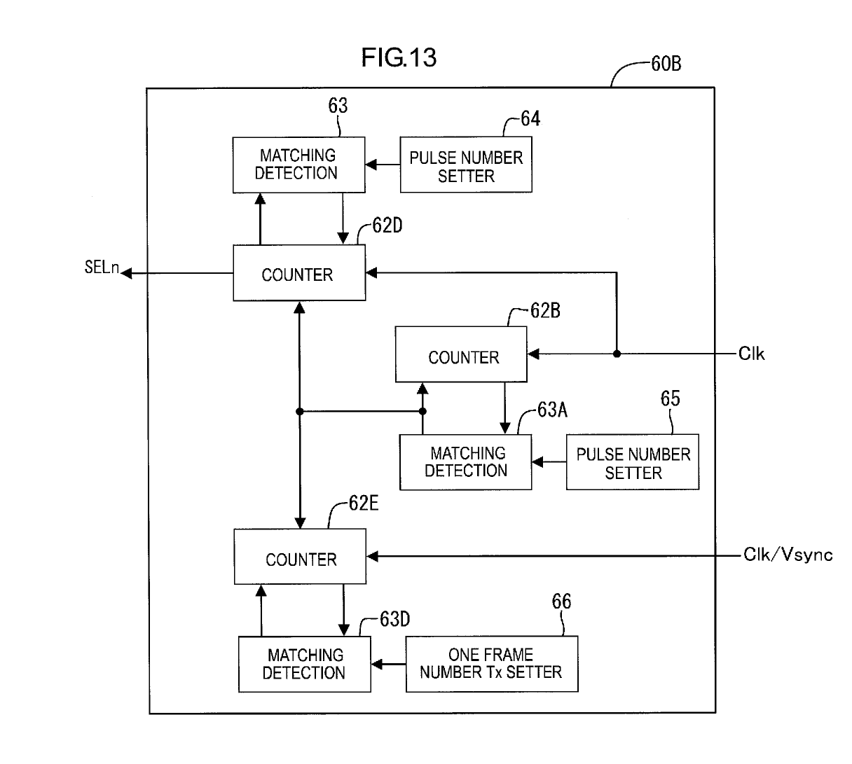

As illustrated in FIG. 13, the selection signal generation circuit 60B includes first to third counters 62D, 62B, 62E, first to third matching detection circuits 63, 63A, 63D, the pulse number setter 64, the cycle setter 65, and the one frame Tx number setter 66.

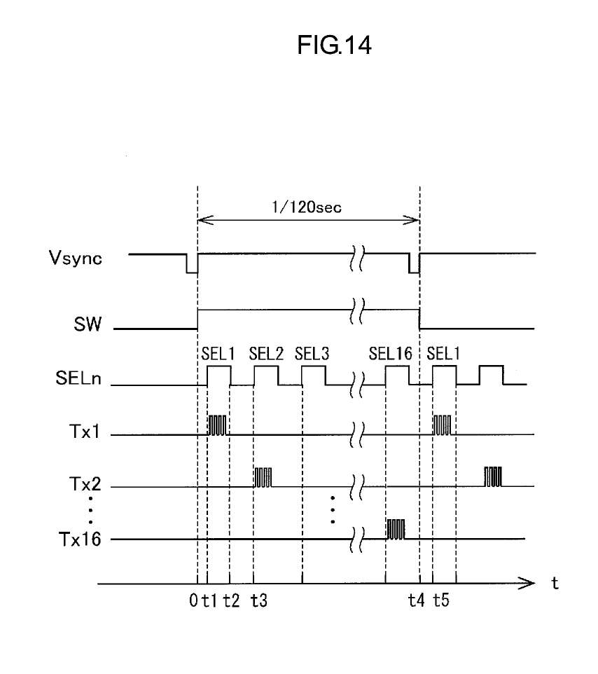

If the first counter 62d detects rising of the vertical synchronizing signal Vsync as the reference signal at the time t0 in FIG. 14, the first counter 62D raises the level of the selection signal SEL1 from the low level to the high level at the time t1 in FIG. 14. At the time t1, a predetermined time has passed from the time t0 in FIG. 14. The predetermined time is counted by counting the clock number of the clock signal Clk.

The selector circuit 73 receives the high-level selection signal SEL1 at the time t1 and switches the common electrode signal SC1 from the switching liquid crystal drive signal SW to the touch panel drive signal Tx1.

The first counter 62D sends the high-level selection signal SEL1 to the touch panel controller 71A as the control signal at the time t1. If receiving the high-level selection signal SEL1 as the control signal, the touch panel controller 71A starts sensing the touch panel 50 and generating the touch panel drive signal Tx1 and sends the touch panel drive signal Tx1 to the selector circuit 73. Therefore, the touch panel drive signal Tx1 is sent to the predetermined common electrodes 34A at the time t1.

The first counter 62D lowers the level of the selection signal SEL1 from the high level to the low level at the time t2 in FIG. 14. At the time t2, a predetermined delay time has passed after the first counter 62D receives the matching signal from the first matching detection circuit 63. In response to the low-level selection signal SEL1, the selector circuit 73 switches the common electrode signal SC1 from the touch panel drive signal Tx1 to the switching liquid crystal drive signal SW. The predetermined delay time is counted by counting the clock number of the clock signal Clk.

If receiving the low-level selection signal SEL1 as the control signal at the time t2 in FIG. 14, the touch panel controller 71A does not sense the touch panel 50 and stops generating the touch panel drive signal Tx1.

The first counter 62D receives the matching signal from the second matching detection circuit 63A and raises the level of the selection signal SEL2 from the low level to the high level at the time t3 in FIG. 14 similarly to the operation executed at the time t1 in FIG. 14. In response to the high-level selection signal SEL2, the selector circuit 73 switches the common electrode signal SC2 from the switching liquid crystal drive signal SW to the touch panel drive signal Tx2 and sends the touch panel drive signal Tx2 to the predetermined common electrodes 34A. Then, the same operation will be repeated until the touch panel drive signal Tx16 is sent to the predetermined common electrodes 34A.

From the time t4 in FIG. 14, the selection signal SELn for the next frame is started to be generated in response to the next vertical synchronizing signal Vsync as the reference signal.

In the third embodiment, the selection signal generation circuit 60B generates the selection signal SELn in response to the vertical synchronizing signal Vsync as the reference signal and sends the selection signal SELn to the selector circuit 73. The selection signal generation circuit 60B also sends the selection signal SELn to the touch panel controller 71A as the control signal of the touch panel controller 71A. The switching liquid crystal drive signal SW and the touch panel drive signal Tx that are not synchronous with each other are surely switched and one of them is sent to the common electrodes 34A.

### Fourth Embodiment

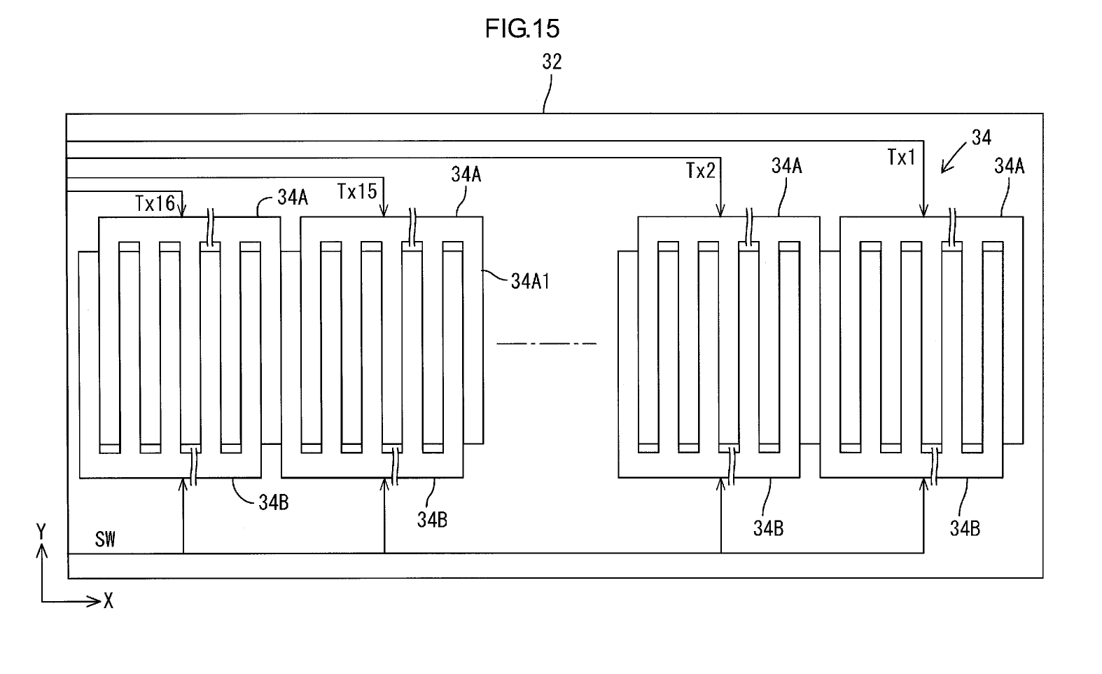

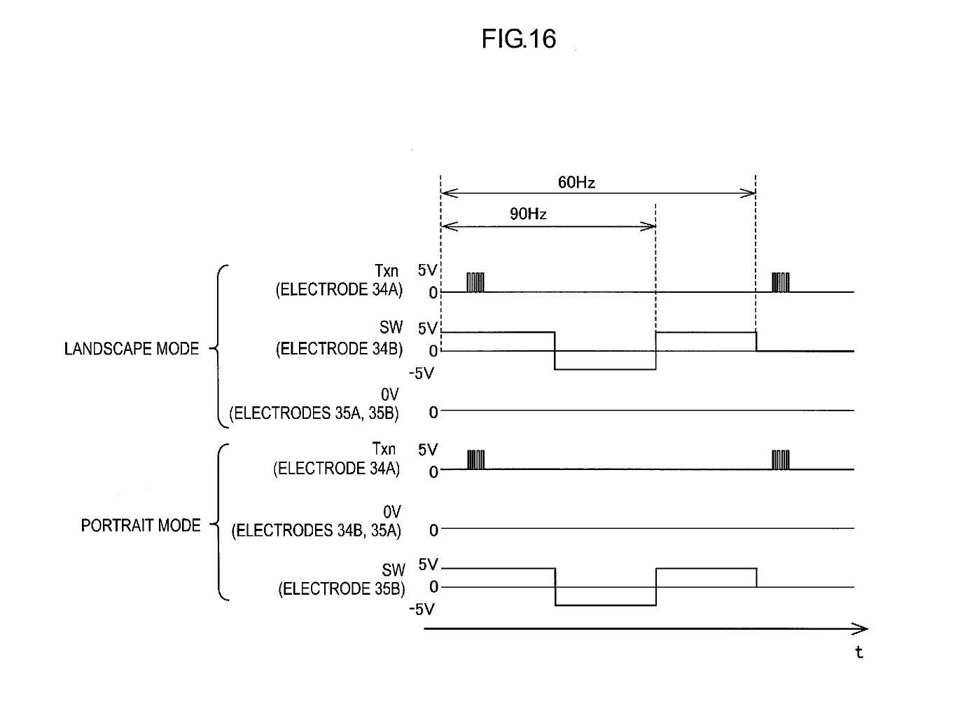

Next, a fourth embodiment will be explained with reference to FIGS. 15 and 16. In the first to third embodiments, the common electrode signal SCn is applied to the common electrodes 34A or the common electrodes 34B. In the fourth embodiment, some of a plurality of electrodes formed on a same surface of the common board 32 are used as touch panel electrodes and another ones of the electrodes are used as switching liquid crystal electrodes. The touch panel drive signal Txn and the switching liquid crystal drive signal SW are applied independently to corresponding electrodes. In the fourth embodiment, a synthesized signal configured with the touch panel drive signal Txn and the switching liquid crystal signal SW is not generated.

In FIG. 15, the electrodes 34A and the electrodes 34B are formed on a lower surface of the common board 32 and the electrodes 34A are the touch panel electrodes and the electrodes 34B are the switching liquid crystal electrodes. Wiring is illustrated in FIG. 15 such that the signals are commonly sent to the electrodes 34B. However, this is not limited thereto. Similarly to the example in FIG. 2, the wiring may be provided such that the signals are independently applied to each of the electrodes 34A.

FIG. 16 illustrates a timing chart of the signals applied to each wiring in the fourth embodiment. As illustrated in FIG. 16, in the landscape mode (the horizontal position), the touch panel drive signal Txn is applied to the electrodes 34A (a first application process), and the switching liquid crystal drive signal SW is applied to the electrodes 34B (a second application process). The switching liquid crystal drive signal SW is formed in a positive-negative symmetrical rectangular waveform (+5V, −5V). A frequency of the switching liquid crystal drive signal SW is 90 Hz, and a sensing frequency of the touch panel 50 is 60 Hz, for example. The electrodes 35A, 35B are at a ground level (0V).

In the portrait mode (the vertical position), the touch panel drive signal Txn is applied to the electrodes 34A and the switching liquid crystal drive signal SW that is formed in a positive-negative symmetrical rectangular waveform is applied to the electrodes 35B. The electrodes 34B, 35A are at a ground level (0V).

Even if a synthesized signal that is configured with the touch panel drive signal Txn and the switching liquid crystal drive signal SW is not generated, each of the switching liquid crystal panel 30 and the touch panel 50 is driven with using the electrodes 34A and 34B formed on the common board 32.

### Other Embodiments

The present invention is not limited to the above embodiments described in the above description and the drawings. The following embodiments are also included in the technical scope of the present invention, for example.

(1) In the above embodiments, the touch panel 50 of a charge transmission method is used. However, a position detection method of the touch panel 50 is not limited thereto.

For example, an electrostatic capacity of sensor electrodes included in the touch panel 50 may be directly measured (self-capacity detection method) to detect positions in the touch panel 50. Each of the touch panel transparent electrodes of the touch panel 50 is not necessarily formed in the shape described in the above embodiments (such that the transparent electrodes each extending in the X-axis and the Y-axis are overlapped with each other in a grid pattern).

(2) In the above embodiments, the switching liquid crystal electrode 34 extending in the Y-axis direction is formed on the common board 32 and the electrode 34 is used as the common electrode commonly used with the touch panel. However, it is not limited thereto. The switching liquid crystal panel electrode 35 extending in the X-axis direction may be formed on the common board 32 and the electrode 35 may be used as the common electrode.

(3) In the above embodiments, the common electrode signal SCn that is a synthesized signal includes the touch panel drive signal Txn and the switching liquid crystal drive signal SW that are switched therebetween with time-sharing. However, it is not limited thereto. For example, the common electrode signal SCn may be obtained by combining the touch panel drive signal Txn and the switching liquid crystal drive signal SW.

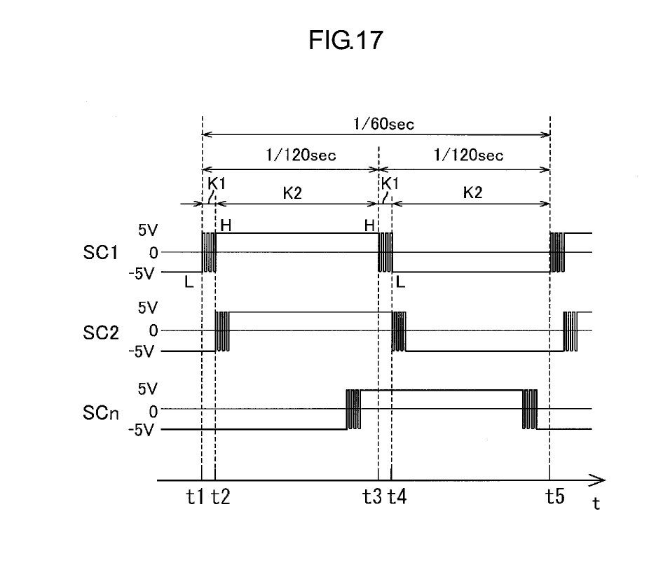

(4) In generating the common electrode signal SCn that is a synthesized signal, as illustrated in FIG. 17, the level of the touch panel drive signal Txn during a non-active period K2 may be switched alternately between the high level and the low level at every non-active period and accordingly the common electrode signal SCn may be generated. Specifically, if each of the touch panel drive signals Tx1 to Txn starts its active period K1 at L (low level), it ends the active period K1 at H (high level) and keeps the H level during the non-active period K2. If each of the touch panel drive signals starts its active period K1 at the H level, it ends the active period K1 at the L level and keeps the L level during the non-active period K2.

For example, if the touch panel drive signal Tx1 starts its active period K1 at the L level at the time t1 in FIG. 17, it ends at the H level at the time t2 and maintains the H level during its non-active period K2. Next, if the touch panel drive signal Tx1 starts its active period K1 at the H level at the time t3, it ends at the L level at the time t4 and maintains the L level during its non-active period until the time t5. Thus, the level of the touch panel drive signal Txn is alternately switched between the H level and the L level during the non-active period K2 and functions as the switching liquid crystal drive signal SW. The common electrode signal Scn configured by synthesizing the touch panel drive signal Txn and the switching liquid crystal drive signal SW is applied to 34A in FIGS. 15 and 34B in FIG. 5 is grounded (0V).

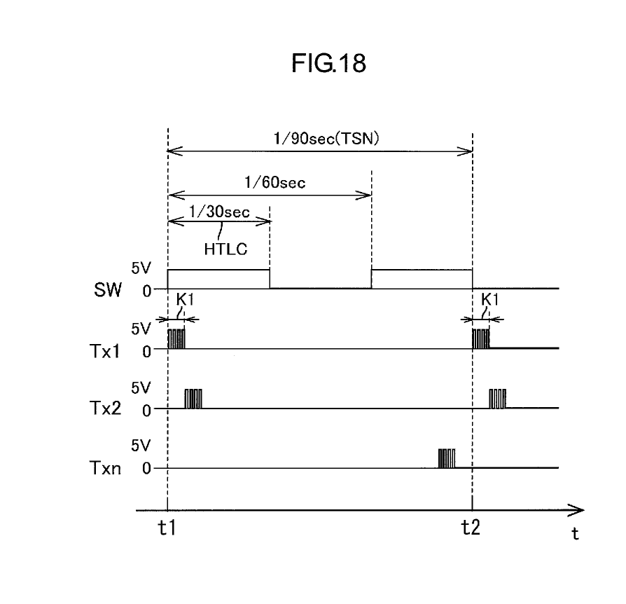

(5) As illustrated in FIG. 18, the sensing cycle TSN may be set to be an odd multiple of a half-cycle HTLC of the switching liquid crystal signal SW. The sensing cycle TSN is a cycle at which an entire area of the touch panel 50 is sensed in response to the touch panel drive signal Txn. In FIG. 18, the sensing cycle TSN is obtained by multiplying the half-cycle HTLC by three. In this case, the level of the switching liquid drive signal SW during the active period K1 of the touch panel drive signal Txn is switched alternately between the high level and the low level. This stabilizes a DC balance.

(6) In the above embodiments, the touch panel drive signal Txn and the switching liquid crystal drive signal SW may be synchronous with each other. In such a case, in response to generation of one of the signals, the other one of the signals is generated. A rising edge or a dropping edge of the switching liquid crystal drive signal SW may be a trigger to generate the touch panel drive signal Txn. Instead, in synchronism with the timing of start or end of the touch panel drive signal Txn, the level of the switching liquid crystal drive signal SW may be switched alternately between the high level and the low level or may be reversed between a positive polarity and a negative polarity.

(7) In the above embodiments, the electrodes 34A, 34B are formed on the lower surface of the common board 32 and the electrodes 34A are the common electrodes. However, it is not limited thereto and the electrodes 34B may be used as the common electrodes.

(8) The display devices of the above embodiments are configured so as to be applied to the portrait mode in which the display screen is in a vertical position and to the landscape mode in which the display screen is in a horizontal position. However, it is not limited thereto. For example, if the parallax barrier is used either one of the two modes, the electrodes 35 on the glass board 31 are not necessarily patterned and may be formed over an entire area of the glass board 31. In such a case, the present technology may be applied to the signal applied to the barrier electrodes formed on the glass board (common board) 32.

(9) In the above embodiments, the liquid crystal display device uses the liquid crystal panel as a display panel. However, the present technology is applicable to a display device using other type of display panel, for example, an EL panel.

### EXPLANATION OF SYMBOLS

10: liquid crystal display device (display device)
20: liquid crystal panel (display panel)
30: switching liquid crystal panel (parallax barrier)
32: common board
34A: common electrode (first touch panel electrode, first switching liquid crystal panel electrode)
35: second switching liquid crystal panel electrode
50: touch panel
60: selection signal generation circuit (selection signal generator)
71: touch panel controller
73: selector circuit (synthesized signal generator)
80, 80A, 80B: drive circuit (drive circuit of display device)

1-27. (canceled)

28. A display device comprising:
a display panel;
a touch panel provided on a display surface side of the display panel;
a switching liquid crystal panel including a parallax barrier that enables three-dimensional display;
a common board that is commonly used as a base board of the touch panel and a base board of the switching liquid crystal panel;
a plurality of electrodes provided on the common board and used for the touch panel and the switching liquid crystal panel; and
a drive circuit configured to apply a synthesized signal to some of the electrodes, the synthesized signal being configured by synthesizing a touch panel drive signal and a switching liquid crystal drive signal.

29. The display device according to claim 28, wherein the synthesized signal is configured by combining the touch panel drive signal and the switching liquid crystal drive signal.

30. The display device according to claim 28, wherein
the touch panel drive signal includes an active period and a non-active period, and
the drive circuit switches a level of the touch panel drive signal during the non-active period alternately between a high level and a low level every non-active period and generates the synthesized signal.

31. The display device according to claim 28, wherein the synthesized signal includes the touch panel drive signal and the switching liquid crystal drive signal that are switched therebetween with time-sharing.

32. The display device according to claim 31, wherein when the drive circuit switches between the touch panel drive signal and the switching liquid crystal drive signal with time-sharing, the synthesized signal has a signal level set to a predetermined one of a high level or a low level just before starting of the touch panel drive signal.

33. The display device according to claim 31, wherein the drive circuit further includes a synthesized signal generator configured to generate the synthesized signal.

34. The display device according to claim 31, wherein the switching liquid crystal drive signal has a pair of rectangular waveforms each of which has a same amplitude and an opposite phase.

35. A display device comprising:
a display panel;
a touch panel provided on a display surface side of the display panel;
a switching liquid crystal panel including a parallax barrier that enables three-dimensional display;
a common board that is commonly used as a base board of the touch panel and a base board of the switching liquid crystal panel;
a plurality of touch panel electrodes and a plurality of switching liquid crystal electrodes provided on a same plane surface of the common board; and
a drive circuit configured to apply a touch panel drive signal to the touch panel electrodes and apply a switching liquid crystal drive signal to the switching liquid crystal electrodes.

36. The display device according to claim 35, wherein the switching liquid crystal drive signal has a positive and negative symmetrical rectangular waveform.

37. The display device according to claim 36, wherein the touch panel is sensed in response to the touch panel drive signal at a sensing cycle, and the sensing cycle is set to be an odd multiple of a half-cycle of the switching liquid crystal signal.

38. The display device according to claim 28, wherein the touch panel drive signal and the switching liquid crystal drive signal are synchronous with each other.

39. The display device according to claim 38, wherein the touch panel drive signal is generated in response to a rising edge or a dropping edge of the switching liquid crystal drive signal.

40. The display device according to claim 38, wherein in synchronous with starting or ending of the touch panel drive signal, the drive circuit switches the level of the switching liquid crystal drive signal alternately between the high level and the low level or changes a polarity of the switching liquid crystal drive signal between a positive polarity and a negative polarity.

41. The display device according to claim 33, wherein the drive circuit further includes:
a touch panel controller configured to generate the touch panel drive signal for driving the touch panel, the touch panel drive signal being configured with a predetermined number of pulses; and
a selection signal generator configured to generate a selection signal for switching between the touch panel drive signal and the switching liquid crystal drive signal, wherein
the common board includes a common electrode to which the touch panel drive signal and the switching liquid crystal drive signal are sent, and
the synthesized signal generator receives the touch panel drive signal and the switching liquid crystal drive signal, and switches between the touch panel drive signal and the switching liquid crystal drive signal in response to the selection signal and generates the synthesized signal, and sends the synthesized signal to the common electrode.

42. The display device according to claim 41, wherein the selection signal generator switches from the switching liquid crystal drive signal to the touch panel drive signal in response to rising of an initial pulse included in the touch panel drive signal, and thereafter switches from the touch panel drive signal to the switching liquid crystal drive signal in response to finishing of counting the predetermined pulses.

43. The display device according to claim 41, wherein
the selection signal generator generates the selection signal based on a number of pulses of the touch panel drive signal, a generation cycle of the touch panel drive signal, and a number of generation times of the touch panel drive signal every predetermined period,
the selection signal generator generates the switching liquid crystal drive signal based on the generated selection signal, and
the selection signal generator sends the generated switching liquid crystal drive signal to the synthesized signal generator.

44. The display device according to claim 43, wherein
the predetermined period is a frame cycle, and
the selection signal generator restarts generating the selection signal every frame cycle.

45. The display device according to claim 41, wherein
the touch panel controller controls a sensing operation of the touch panel by a control signal,
the selection signal generator starts generating the selection signal in response to a vertical synchronous signal as a reference signal,
the selection signal generator generates the selection signal based on the vertical synchronous signal, a number of pulses of the touch panel drive signal, a generation cycle of the touch panel drive signal, and a number of generation times of the touch panel drive signal every predetermined period, and
the selection signal generator sends the selection signal to the synthesized signal generator and sends the selection signal to the touch panel controller as the control signal.

46. The display device according to claim 45, wherein the predetermined period is a frame cycle.

47. The display device according to claim 28, wherein
the touch panel drive signal has a minimum pulse width of 100 microseconds or less, and
the switching liquid crystal drive signal has a pulse width of 1 milliseconds or more.
